(19) United States
(12) Patent Application Publication
(10) Pub. No.: US 2009/0090181 A1
(43) Pub. Date: Apr. 9, 2009

(54) SYSTEM AND METHOD FOR INDICATING LIQUID LEVEL WITHIN A RECEPTACLE

(75) Inventors: Thomas K. Reusche, Elburn, IL (US); Philip E. Chumbley, Aurora, IL (US)

Correspondence Address: MCANDREWS HELD & MALLOY, LTD, 500 WEST MADISON STREET, SUITE 3400, CHICAGO, IL, 60661, US

(73) Assignee: ALLIED PRECISION INDUSTRIES, INC., Elburn, IL (US)

(21) Appl. No.: 12/242,194

(22) Filed: Sep. 30, 2008

Related U.S. Application Data
(60) Provisional application No. 60/978,668, filed on Oct. 9, 2007.

(51) Int. Cl. G01F 23/76

(52) U.S. Cl. 73/322.5

(57) ABSTRACT

A system for indicating a level of liquid within a container includes a float housing, a float within the float housing, a cover cap secured to the float housing through a tube, and a rod connected to the float and slidably retained with the tube. The float is configured to move a controlled distance within the float housing in relation to a level of the liquid within the float housing. A distal end of the rod is positioned within the cover cap. The distal end of the rod is configured to indicate a liquid level based on movement caused by the float within the float housing.

### RELATED APPLICATIONS

The present application relates to and claims priority from U.S Provisional Application No. 60/978,668, entitled “Liquid Level Indicator,” which was filed on Oct. 9, 2007, and is hereby incorporated by reference in its entirety.

### FIELD OF EMBODIMENTS OF THE PRESENT INVENTION

Embodiments of the present invention generally relate to a liquid level indicator, and more particularly to a system and method configured to allow a level of a liquid within a container to be observed without the need to look inside a liquid receptacle.

### BACKGROUND

Liquid-retaining receptacles are used for various applications. Examples of liquid-retaining receptacles include bird baths, water bottles, livestock water troughs, water towers, and the like. In each instance, the receptacles are used to maintain a certain amount of liquid therein.

Typically, one visually inspects a liquid-retaining receptacle to determine the amount of liquid contained therein. The intended purpose of the receptacle may be rendered moot if the receptacle is empty. For example, a bird cannot bathe in a bird bath without water.

In many instances, one may overlook the fact that a receptacle is empty. Typically, one determines that the receptacle is empty only upon a visual examination, and may realize that he/she should have acted quicker to refill the receptacle. For example, a pet may go thirsty for an extended period of time due to the fact that its owner did not realize a watering bowl was empty.

A daily chore in raising livestock is to provide food and water. For example, a farmer owning cattle or a rancher with horses typically needs to maintain a sufficient supply of drinking water for the animals' consumption. In both cases, water is typically provided in buckets, troughs or tanks. An attendant is then responsible for ensuring that the containers are supplied with water.

A horse typically drinks about fifteen gallons of water per day. If a five gallon bucket is used for supplying the water to the horse, the bucket typically needs to be filled a minimum of three times per day. As such, the attendant periodically checks the water level in the bucket throughout the day. If the bucket is mounted inside a stall, the attendant may need to enter the stall in order to look inside the bucket.

### SUMMARY OF THE INVENTION

Certain embodiments of the present invention provide a system for indicating a level of liquid within a container, such as a bucket, trough, tank, birdbath or the like. The system includes a float housing, a float within the float housing, a cover cap secured to the float housing through a tube, and a rod connected to the float and slidably retained within the tube.

The float is configured to move a controlled distance within the float housing in relation to a level of the liquid within the float housing. A distal end of the rod is positioned within the cover cap and is configured to indicate a liquid level based on movement of the float within the float housing.

The cover cap may include an opaque end and a transparent end. The distal end of the rod may include an indication of a low liquid level, wherein the indication of the low liquid level is hidden by the opaque end when the float is at a high level within the float housing. The indication of the low liquid level shows through the transparent end when the float is at a predetermined level within the float housing that is lower than the high level. The indication of the low liquid level may include a distinct color, such as red or orange. The indication of the low liquid level may be hidden by the opaque end when a top of the float abuts an interior surface of a top wall of the float housing. The distal end of the rod may include a plurality of liquid level indicators in addition to the indication of the low liquid level.

The system may include a magnetic switch secured to a portion of the cover cap and a magnet secured to the distal end of the rod. The system may also include a light emitting diode electrically connected to the magnetic switch, wherein the light emitting diode activates when the magnet passes by the magnetic switch in a first direction (such as when the magnet moves down toward and past the switch). The light emitting diode deactivates when the magnet passes by the magnetic switch in a second direction that is opposite the first direction.

In another embodiment, the magnetic switch may be in communication with a remote device. The magnetic switch sends a low liquid level signal to the remote device when the magnet passes by the magnetic switch in a first direction. The magnetic switch cancels the low liquid level signal when the magnet passes by the magnet switch in a second direction that is opposite the first direction.

The tube and the rod may be straight. Alternatively, the tube and the rod may be bent, such that a portion of the tube includes an expanded diameter to allow movement of the rod therein. The system may also include an extension tube connected to the tube.

Certain embodiments of the present invention provide a system for indicating a level of liquid, including a liquid container configured to retain liquid within a liquid chamber, and a liquid level indicator apparatus. The liquid level indicator apparatus includes a float housing positioned within the liquid chamber, a float within the float housing, a cover cap secured to the float housing through a tube that is secured to the liquid container, and a rod connected to the float and slidably retained within the tube. The float is configured to move a controlled distance within the float housing in relation to a level of the liquid within the float housing. The cover cap is positioned outside of the liquid chamber.

Certain embodiments of the present invention provide a system for indicating a level of liquid within a container that includes a float housing, a float within the float housing, a cover cap secured to the float housing through a tube, a rod connected to the float and slidably retained within the tube, a magnetic switch secured to a portion of the cover cap, and a magnet secured to the distal end of the rod. The float is configured to move a controlled distance within the float housing in relation to a level of the liquid within the float housing. The cover cap includes an opaque end and a transparent end. A distal end of the rod is positioned within the cover cap. The distal end of the rod is configured to indicate a liquid level based on movement of the float within the float housing.

The distal end of the rod includes an indication of a low liquid level. The indication of the low liquid level is hidden by the opaque end when the float is at a high level within the float housing. The indication of the low liquid level shows through the transparent end when the float is at a predetermined level within the float housing that is lower than the high level. The indication of the low liquid level is hidden by the opaque end when a top of the float abuts an interior surface of a top wall of the float housing.

A low liquid level signal for the indication of the low liquid level is activated when the magnet passes by the magnetic switch in a first direction. The low liquid level signal is canceled when the magnet passes by the magnetic switch in a second direction that is opposite the first direction.

### BRIEF DESCRIPTION OF SEVERAL VIEWS OF THE DRAWINGS

FIG. 1 illustrates a partial cross-sectional view of a liquid level indicator apparatus, according to an embodiment of the present invention.

FIG. 2 illustrates an internal view of a liquid container having a liquid level indicator apparatus secured therein, according to an embodiment of the present invention.

FIG. 3 illustrates a partial cross-sectional view of a liquid level indicator apparatus with an extension tube, according to an embodiment of the present invention.

FIG. 4 illustrates a liquid level indicator apparatus, according to an embodiment of the present invention.

FIG. 5 illustrates a partial cross-sectional view of a liquid level indicator apparatus, according to an embodiment of the present invention.

The foregoing summary, as well as the following detailed description of certain embodiments of the present invention, will be better understood when read in conjunction with the appended drawings. For the purpose of illustrating the invention, there is shown in the drawings, certain embodiments. It should be understood, however, that the present invention is not limited to the arrangements and instrumentalities shown in the attached drawings.

### DETAILED DESCRIPTION OF EMBODIMENTS OF THE PRESENT INVENTION

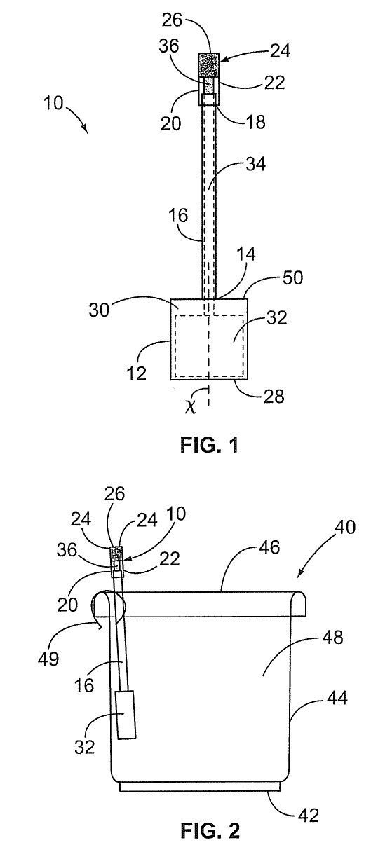

FIG. 1 illustrates a partial cross-sectional view of a liquid level indicator apparatus 10, according to an embodiment of the present invention. The apparatus 10 includes a float housing 12 connected to a bottom end 14 of a hollow tube 16. The bottom end 14 is secured to or within an opening (not shown) formed within a top of the float housing 12. For example, the opening may be formed through an axial center of the float housing 12 and the bottom end 14 may be threadably secured therein. The bottom end 14 of the tube 16 may be secured to the float housing 12 through various other ways, such as for example, bonding, gluing, fasteners, or the like.

A top end 18 of the tube 16 is secured to or within a cover cap 20. For example, an internal surface of the cover cap 20 may be threaded and threadably engages a threaded outer surface of the top end 18 of the tube 16.

The cover cap 20 includes a transparent lower portion 22 and an upper opaque portion 24. The cover cap 20 may be formed of various materials, such as glass, plastic or the like. A hole 26 is formed through a top of the cover cap 18 and is configured to allow air to pass therethrough.

A lower end 28 of the float housing 12 is open to allow liquid to pass into a float chamber 30 of the float housing 12. Optionally, the float housing 12 may include a closed lower end. In this case, openings may be formed throughout the float housing 12 in order to allow liquid to pass into the float chamber 30.

A float 32 is positioned within the float chamber 30. The float 32 may be formed of various buoyant materials, such as foam, inflated rubber or the like. The float 32 is sized so that it cannot escape through the lower end 28 of the float housing 12. For example, the lower end 28 may include a circumferential lower lip that extends toward a longitudinal axis X of the apparatus 10. The diameter of the float 32 is larger than the opening formed through the lower end 28 so that the float 32 cannot escape through the lower end 28.

The float 32 is secured to a rod 34 that extends through the tube 16 and into the cover cap 20. The rod 34 is slidably secured within the tube 16 and the cover cap 20. A distal end 36 of the rod 34 includes indicators. The indicators may be color coded, numerical, or text. For example, a tip of the indicator may be red, while a middle portion may be yellow, and a lower portion may be green.

FIG. 2 illustrates an internal view of a liquid container 40 having the liquid level indicator apparatus 10 secured therein, according to an embodiment of the present invention. The liquid container 40 may be a bucket, trough, tank or the like including a base 42 integrally connected to a cylindrical upstanding wall 44. The wall 44 need not be circular in axial cross section. The term cylindrical is used to denote that it fully extends around the container 40. The liquid container 40 includes an open upper end 46 that allows access to a liquid retaining chamber 48 defined by the base 42 and the upstanding wall 44.

The apparatus 10 is secured within the liquid retaining chamber 48 such that the cover cap 20 extends above the top of the container 40. The apparatus 10 may be secured to an interior surface of the upstanding wall 44 through a clip 49 that securely fastens the tube 16 to the container 40. Optionally, the apparatus 10 may be secured to the container 40 through fasteners, such as screws or bolts, clamps, bonding or the like.

Referring to FIGS. 1 and 2, in operation, when liquid is within the chamber 48, the liquid passes into the float chamber 30. When the float is fully submerged, the buoyant nature of the float 32 causes it to abut into a top wall 50 of the float chamber 30. Thus, the rod 34 is fully extended through the tube 16 such that a top indicator portion of the rod 16 is positioned within the opaque portion 24 of the cover cap 20. In this manner, the top indicator portion is hidden from view by the opaque portion 24. Other indicators at the distal end 36 of the rod 34 may be visible through the transparent portion 22 of the cover cap 20. For example, in the fully extended position in which the float 32 abuts a top wall 50 of the float housing 12 (because the float 32 is submerged in water), a green indicator denoting adequate water supply may show through the transparent lower portion 22 of the cover cap 20. Optionally, the visible indicator may be text such as “full,” or various other indications of an adequate water supply.

As water is removed from the container 40, the float 32 recedes within the float housing 12. Thus, the rod 34 moves through the tube 16 in response. Consequently, the distal end 36 of the rod 34 recedes within the cover cap 20. The indicators on the distal end 36 are configured based on an operator's specifications. For example, the operator may determine that a low level indicator be shown when the water within the container 40 reaches a certain level. The operator may apply indicators on the distal end 36 accordingly.

The distal end 36 of the rod 34 may include a variety of indicators. The top of the distal end 36 indicates a low water level. The length of the level indicator on the rod 34 may vary, depending on a particular application and an operator's preferences. The low water level indicator may be red, for example. A medium level indicator may be below the lower level indicator. The medium level indicator may be yellow. A full level indicator may be below the medium level indicator. The medium level indicator may be green. Optionally, the indicators may be various other visual cues. Also, alternatively, the distal end 36 of the rod 34 may include only the low level indicator.

In any event, when the float 32 recedes within the float housing 12 to a predetermined low level, the rod 34 recedes within the tube 16 and the low level indicator at the distal end 36 of the rod 34 shows through the transparent lower portion 22 of the cover cap 20. In this manner, the apparatus 10 provides a readably discernable visual cue to an attendant that the container 40 needs to be refilled with water. As such, the attendant does not need to visually inspect the contents of the container 40 to determine the level of water within the container 40. Instead, the attendant may see from afar (instead of entering an animal stall in which the container 40 is located) if the container 40 needs refilling.

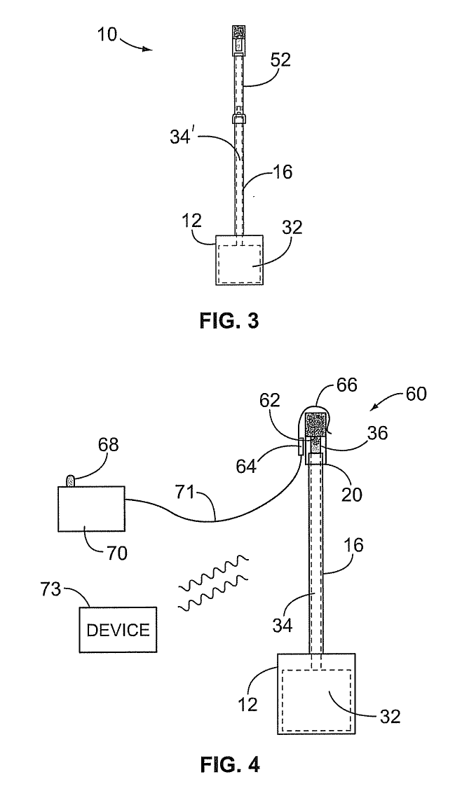

FIG. 3 illustrates a partial cross-sectional view of a liquid level indicator apparatus 10 with an extension tube 52, according to an embodiment of the present invention. In order to accommodate deeper liquid containers, the tube 16 may be connected to the extension tube 52. For example, a lower end of said extension tube 52 may threadably secure to an upper end of said tube, such as through an adapter. A longer rod 34′ may be slidably secured within the tube 16. The apparatus 10 operates similarly to that described above.

FIG. 4 illustrates a liquid level indicator apparatus 60, according to an embodiment of the present invention. The apparatus 60 is similar to the embodiments described above, except that, instead of the distal end 36 of the rod 34 having visual indicators, a magnet 62 is secured to a top portion or tip of the distal end 36. A magnetic switch 64 is secured to an outer surface of the cover cap 20. The magnetic switch 64 may be positioned at a lower portion of the cover cap 20. The switch 64 may be secured to the cover cap 20 through a clamp or clip 66. As such, the switch 64 may be selectively positioned on the cover cap 20 based on an operator's determination of a low water level. Optionally, the magnetic switch 64 may be secured to the cover cap 20 through various fasteners, bonding, gluing, or the like.

In operation, as the distal end 36 of the rod 34 recedes within the cover cap 20, the magnet 62 passes by the magnetic switch 64. The magnetic field of the magnet 62 causes the magnetic switch 64 to close a circuit that includes an indicator light emitting diode (LED) 68. The LED 68 and the switch 64 are powered by a battery within a battery housing 70. Optionally, the LED 68 and the switch 64 may be configured to be powered through a standard wall outlet. The lit LED 68 indicates to an attendant a low water state. When water is filled back into the container, the rod moves back toward the top of the cover cap 20. As the magnet 62 passes the magnetic switch 64, the switch opens the circuit, thereby deactivating the LED 68.

As shown in FIG. 4, the battery housing 70 and the LED 68 are remotely located from the cover cap 20. The battery housing 70 may be electrically connected to the switch 64 through insulated wiring 71. The LED 68 and battery housing 70 may be positioned away from a liquid container so that an animal is less susceptible to contacting them. Optionally, the battery housing 70 and the LED 68 may be directly mounted on the cover cap 20.

Additionally, the switch 64 and magnet 62 may be configured to transmit a signal electronically or via radio frequency to a remote device 73, such as a computer, cell phone or the like in order to alert an attendant of a low water condition. That is, the magnetic trigger may alert an attendant who is not within sight of the apparatus 60. For example, the switch 64 may be in communication with the device, either through a wired or wireless connection. When the magnet 62 drops down and passes by the switch 64, the switch relays a low liquid level signal to the remote device 73. When liquid fills the container so that the magnet 62 moves upwardly past the switch 64, the switch 64 cancels the low liquid level signal. That is, the switch 64 no longer sends the low liquid level sensor, or it instructs the device 73 to discontinue a low liquid level alert.

While the magnetic switch 64 is shown on the outside of the cover cap 20, the magnetic switch 64 may optionally be located within the cover cap 20. Also, alternatively, the cover cap 20 in this embodiment may be fully transparent or fully opaque, as the low level indicator is based on the magnet 62 causing the magnetic switch 64 to close a circuit to activate the LED 68. As such, visual indicators on the rod 34 are not necessary.

However, the cover cap 20 may be opaque and transparent as discussed above with respect to FIGS. 1-2 in order to provide a redundant system. In this manner, if a low level indicator on the rod 34 shows through the transparent portion of the cover cap 20, but the LED 68 is not activated, an operator can easily determine that the system may be malfunctioning. For example, such a situation alerts an operator that the battery may need to be replaced.

Additionally, the apparatus 60 may include an extension, such as described above with respect to FIG. 3.

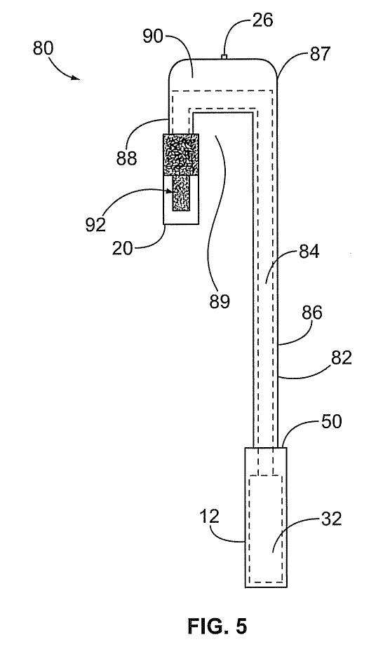

FIG. 5 illustrates a partial cross-sectional view of a liquid level indicator apparatus 80, according to an embodiment of the present invention. The apparatus 80 may be similar to the embodiments discussed above with respect to FIGS. 1-4, except that the tube 82 and the rod 84 are bent to curl around a lip of the container so that an animal is less susceptible to contacting the cover cap 20. The cover cap 20 is configured to be positioned below a lip of a liquid container so that an animal is less susceptible to chewing on the apparatus 80.

The tube 82 includes an upward extension 86 that is configured to be positioned within a liquid container. The extension 86 connects to a horizontal bend 87 that, in turn, connects to a vertical bend 88 that may be parallel with the extension 86. As shown in FIG. 5, the vertical bend 88 downwardly bends from the horizontal bend 87. The tube 82 forms a bracket having a container lip area 89 is defined between the vertical bend 88, the horizontal bend 87 and the extension 86. The apparatus 80 may hang on a lip of a liquid container by way of the container lip area 89.

The rod 84 is shaped in a similar fashion. The open area 90 within the horizontal bend 87 is expanded as compared to the extension 86 and the vertical bend 88. The expanded area 87 allows the bent area of the rod to move therein based on the position of the float 32.

The distal tip 92 of the cover cap 20 includes a low water indicator, as discussed above. When the float 32 is pushed against the top wall 50 of the float housing 12, the distal tip 92 is hidden by the opaque upper portion of the cover cap 20. When the float 32 recedes within the float housing 12, the distal tip 92 is exposed through the transparent portion of the cover cap 20.

Thus, embodiments of the present invention provide a system and method of determining whether a liquid container, such as a bucket, trough, tank or the like, is low on water without an attendant physically inspecting the liquid level within the container. For example, if the container is located within a livestock stall, the attendant does not need to enter the stall to determine whether the container is low. Instead, the attendant is able to determine whether a low liquid level exists by viewing the low level indicator. In this way, labor and time are saved.

While various spatial terms, such as upper, bottom, lower, mid, lateral, horizontal, vertical, and the like may used to describe embodiments of the present invention, it is understood that such terms are merely used with respect to the orientations shown in the drawings. The orientations may be inverted, rotated, or otherwise changed, such that an upper portion is a lower portion, and vice versa, horizontal becomes vertical, and the like.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A system for indicating a level of liquid within a container, the system comprising:
a float housing;
a float within said float housing, wherein said float is configured to move a controlled distance within said float housing in relation to a level of the liquid within said float housing;
a cover cap secured to said float housing through a tube; and
a rod connected to said float and slidably retained within said tube, wherein a distal end of said rod is positioned within said cover cap, said distal end of said rod configured to indicate a liquid level based on movement of said float within said float housing.

2. The system of claim 1, said cover cap comprising an opaque end and a transparent end, said distal end of said rod comprising an indication of a low liquid level, wherein said indication of the low liquid level is hidden by said opaque end when said float is at a high level within said float housing, and wherein said indication of the low liquid level shows through said transparent end when said float is at a predetermined level within said float housing that is lower than the high level.

3. The system of claim 2, wherein said indication of the low liquid level comprises a distinct color.

4. The system of claim 2, wherein said indication of the low liquid level is hidden by said opaque end when a top of said float abuts an interior surface of a top wall of said float housing.

5. The system of claim 2, said distal end of said rod comprising a plurality of liquid level indicators in addition to said indication of the low liquid level.

6. The system of claim 1, comprising:
a magnetic switch secured to a portion of said cover cap; and
a magnet secured to said distal end of said rod.

7. The system of claim 5, comprising a light emitting diode electrically connected to said magnetic switch, wherein said light emitting diode activates when said magnet passes by said magnetic switch in a first direction, and wherein said light emitting diode deactivates when said magnet passes by said magnetic switch in a second direction that is opposite the first direction.

8. The system of claim 5, wherein said magnetic switch is in communication with a remote device, wherein said magnetic switch sends a low liquid level signal to said remote device when said magnet passes by said magnetic switch in a first direction, and wherein said magnetic switch cancels the low liquid level signal when said magnet passes by said magnet switch in a second direction that is opposite the first direction.

9. The system of claim 1, wherein said tube and said rod are straight.

10. The system of claim 1, wherein said tube and said rod are bent, a portion of said tube comprising an expanded diameter to allow movement of said rod therein.

11. The system of claim 1, comprising an extension tube connected to said tube.

12. A system for indicating a level of liquid, the system comprising:
a liquid container configured to retain liquid within a liquid chamber; and
a liquid level indicator apparatus comprising:
a float housing positioned within said liquid chamber;
a float within said float housing, wherein said float is configured to move a controlled distance within said float housing in relation to a level of the liquid within said float housing;
a cover cap secured to said float housing through a tube that is secured to said liquid container, said cover cap being positioned outside of said liquid chamber; and
a rod connected to said float and slidably retained within said tube, wherein a distal end of said rod is positioned within said cover cap, said distal end of said rod indicating a liquid level within said liquid chamber based on movement of said float within said float housing.

13. The system of claim 12, said cover cap comprising an opaque end and a transparent end, said distal end of said rod comprising an indication of a low liquid level, wherein said indication of the low liquid level is hidden by said opaque end when said float is at a high level within said float housing, and wherein said indication of the low liquid level shows through said transparent end when said float is at a predetermined level within said float housing that is lower than the high level.

14. The system of claim 13, wherein said indication of the low liquid level comprises a distinct color.

15. The system of claim 13, wherein said indication of the low liquid level is hidden by said opaque end when a top of said float abuts an interior surface of a top wall of said float housing.

16. The system of claim 13, said distal end of said rod comprising a plurality of liquid level indicators in addition to said indication of the low liquid level.

17. The system of claim 12, comprising:
a magnetic switch secured to a portion of said cover cap; and
a magnet secured to said distal end of said rod.

18. The system of claim 17, comprising a light emitting diode electrically connected to said magnetic switch, wherein said light emitting diode activates when said magnet passes by said magnetic switch in a first direction, and wherein said light emitting diode deactivates when said magnet passes by said magnetic switch in a second direction that is opposite the first direction.

19. The system of claim 17, wherein said magnetic switch is in communication with a remote device, wherein said magnetic switch sends a low liquid level signal to said remote device when said magnet passes by said magnetic switch in a first direction, and wherein said magnetic switch cancels the low liquid level signal when said magnet passes by said magnet switch in a second direction that is opposite the first direction.

20. The system of claim 12, wherein said tube and said rod are straight, said cover cap extending above said liquid container.

21. The system of claim 12, wherein said tube and said rod are bent, a portion of said tube comprising an expanded diameter to allow movement of said rod therein, wherein said cover cap is positioned on a side of said liquid container outside of said liquid chamber.

22. The system of claim 12, comprising an extension tube connected to said tube.

23. A system for indicating a level of liquid within a container, the system comprising:
a float housing;
a float within said float housing, wherein said float is configured to move a controlled distance within said float housing in relation to a level of the liquid within said float housing;
a cover cap secured to said float housing through a tube, said cover cap comprising an opaque end and a transparent end;
a rod connected to said float and slidably retained within said tube, wherein a distal end of said rod is positioned within said cover cap, said distal end of said rod configured to indicate a liquid level based on movement of said float within said float housing, said distal end of said rod comprising an indication of a low liquid level, wherein said indication of the low liquid level is hidden by said opaque end when said float is at a high level within said float housing, and wherein said indication of the low liquid level shows through said transparent end when said float is at a predetermined level within said float housing that is lower than the high level, wherein said indication of the low liquid level is hidden by said opaque end when a top of said float abuts an interior surface of a top wall of said float housing;
a magnetic switch secured to a portion of said cover cap; and
a magnet secured to said distal end of said rod, wherein a low liquid level signal for said indication of the low liquid level is activated when said magnet passes by said magnetic switch in a first direction, and wherein the low liquid level signal is canceled when said magnet passes by said magnetic switch in a second direction that is opposite the first direction.

24. The system of claim 23, wherein said indication of the low liquid level comprises a distinct color.

25. The system of claim 23, said distal end of said rod comprising a plurality of liquid level indicators in addition to said indication of the low liquid level.

26. The system of claim 23, comprising a light emitting diode electrically connected to said magnetic switch, wherein said low liquid level signal activates said light emitting diode when said magnet passes by said magnetic switch in a first direction, and wherein cancellation of said low liquid level signal deactivates said light emitting diode.

27. The system of claim 23, comprising a remote device in communication with said magnetic switch, wherein said magnetic switch sends said low liquid level signal to said remote device when said magnet passes by said magnetic switch in a first direction.
